(19) United States
(12) Patent Application Publication
(10) Pub. No.: US 2006/0202598 A1
(43) Pub. Date: Sep. 14, 2006

(54) High-pressure discharge lamp

(75) Inventors: Holger Möench, Vaals (NL); Arnd Ritz, Heinsberg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/565,146

(22) PCT Filed: Jul. 12, 2004
(86) PCT No.: PCT/IB04/51200

§ 371 Date: Jan. 19, 2006

(30) Foreign Application Priority Data
Jul. 22, 2003 (EP) 03102251.0

(51) Int. Cl. H01J 61/40; H01J 5/16; H01K 1/26; H01K 1/30

(52) U.S. Cl. 313/112

(57) ABSTRACT

The invention relates to a high-pressure discharge lamp, which emits light at least in a defined wavelength range with a defined emission spectrum, having at least one burner (2), which comprises a discharge chamber (21), wherein at least the outer contour of the burner (2) has an elliptical shape in the area of the discharge chamber (21), two electrodes (41, 42) extending into the discharge chamber (21) which are arranged opposite one another and on the longest axis of symmetry of the discharge chamber (21), and a multilayer interference filter (3), which is arranged at least on th outer contour of the burner (2) in the area of the discharge chamber (21), wherein at least a portion of the light from the defined wavelength range may pass through the interference filter (3) and another portion of the light from the defined wavelength range may be reflected into the space between the two electrodes (41, 42).

The invention relates to a high-pressure discharge lamp, which emits light at least in a defined wavelength range with a defined emission spectrum. The invention further relates to a lighting system, which emits light at least in a defined wavelength range with a defined emission spectrum.

High-pressure gas discharge lamps (HID [high intensity discharge] lamps) and in particular UHP (ultra high performance) lamps are used inter alia preferably for projection purposes because of their optical properties. For the purposes of the invention, the designation UHP lamp (Philips) also covers UHP-type lamps made by other manufacturers.

For these applications, a light source which is as far as possible punctiform is generally required, such that the arc forming between the electrode tips does not exceed a given length. In addition, the highest possible light intensity is generally desired, whilst retaining as far as possible the natural spectral composition of the visible light. The type of light source and operation thereof in each case determine a given emission spectrum for the emitted light.

In the case of certain light-related applications, a desired and thus defined wavelength range is required with a desired emission spectrum thus defined with regard to its parameters, which spectrum differs from the above-mentioned conventional emission spectrum of the light source. If this light source is nonetheless to be used, adaptation has to be effected in a known manner using additional components, in order to obtain the desired defined emission spectrum.

UHP lamps are less well suited, for example, to applications with demanding requirements with regard to color rendering, because of their given spectral distribution inter alia with a very high color temperature of approx. 7500 K. There is thus a need for adaptation using additional means, for example absorption filters, and measures which are associated as a rule with additional costs.

Although high-pressure gas discharge lamps exhibit improved efficiency relative to incandescent lamps for example, further improvement of the efficiency thereof is the focal point of development in relation to high-pressure gas discharge lamps.

One basic approach to the problem of increasing the efficiency of a gas discharge lamp, by reflection of undesired radiation back into the area of the arc, is known from U.S. Pat. No. 3,931,536. In this instance, at least partial reabsorption of the undesired radiation takes place in the arc, wherein this energy input serves to increase the efficiency of the lamp, in accordance with the object. A multilayer interference filter is used as reflector, for example. At least those portions of the spectrum of light emitted by the arc which would not otherwise be usable for lighting purposes are reabsorbed. Purposeful influencing of the respective emission spectrum in the desired wavelength range of the light, i.e. a range with defined parameters, is not possible with the solution expounded.

It is therefore an object of the invention to provide a high-pressure gas discharge lamp of the above-mentioned type and a lighting unit with such a lamp, which has an interference filter which may be effectively produced by industrial mass production and which ensures the emission of light in a defined wavelength range with a defined emission spectrum.

The object of the invention is achieved by the features of claim 1.

The lamp according to the invention comprises at least one burner, which comprises a discharge chamber, wherein at least the outer contour of the burner has an elliptical shape in the area of the discharge chamber, two electrodes extending into the discharge chamber, which are arranged opposite one another and on the longest axis of symmetry of the discharge chamber, and a multilayer interference filter, which is arranged on the outer contour of the burner in the area of the discharge chamber, wherein at least a portion of the light from the defined wavelength range may pass through the interference filter and another portion of the light from the defined wavelength range may be reflected into the space between the two electrodes.

The other portion of the light from the defined wavelength range, which is reflected into the space between the two electrodes, i.e. the area of the arc or of the plasma, has not previously passed through this interference filter.

For significant reabsorption in the plasma or in the arc, which takes place most extensively in the space between the two electrodes, it is necessary for the reflected portion of the light from the interference filter to enter this space directly through radiation. In this case, the size of the reabsorbed fraction must be so set, for example by appropriate tests, that the desired overall effect of the possibly multiple passage of the reflected fractions of the light through the arc results in the desired emission spectrum. In this respect, setting as mentioned above is made possible in particular by the selection of a corresponding interference filter or the design thereof. Selection of a corresponding interference filter is readily achievable especially for attenuation of the emission lines.

In this respect, use is made of the empirical proposition that substances or media, such as plasma, which are exposed to irradiation with electromagnetic waves, absorb in particular those frequencies which they may also emit themselves

For this reason, the entire wavelength range of the light is not generally reflected to the same degree by the interference filter. As a rule, only one wavelength range or a plurality of wavelength ranges is reflected wholly or partially in selective manner. In this respect, setting according to the invention of the desired emission spectrum takes place in particular as a result of purposeful lowering of the power of the high-energy wavelength ranges (emission lines) in the desired wavelength range. Selection of the respective wavelength range of the light which is to be reflected at the interference filter is effected in particular from an energy point of view, i.e. the relevant wavelength range has in particular to have sufficient power, which may be at least partially absorbed in the plasma after reflection at the interference filter.

Further criteria for selection of the interference filter are the necessary temperature stability and the characteristic of being suitable for industrial mass production.

Interference filters are primarily suitable as such reflectors because of the sharp transitions between the spectral ranges to be transmitted and reflected. If the layer sequences are designed appropriately, filter characteristics may be produced within wide ranges and with the necessary high level of accuracy.

In addition to the supply of electrical power, this reabsorption of the radiation constitutes an additional supply of energy for the arc, which again serves to generate the respective light spectrum of the respective lamp type. The additional advantage is then achieved that this energy enters the arc more efficiently than via the electrodes, where not inconsiderable electrode losses are encountered.

To what extent this desired reabsorption may contribute to the achievement of the desired emission spectrum is dependent in particular on the respective type of high-pressure gas discharge lamp.

If the interference filter is arranged on virtually the entire outer contour of the discharge chamber or the burner, a larger fraction of the reflected radiation may as a rule be used for reabsorption due to interreflection than in the case of an interference filter in the form of a partial coating.

The dependent claims contain advantageous further developments of the invention.

It is preferable for the layer structure of the multilayer interference filter to be such that a layer with a higher refractive index alternates with a layer with a lower refractive index.

Such interference filters are generally of multilayer construction. In the case of a multilayer construction of the interference filter, layers with a higher refractive index alternate with layers with a lower refractive index. The refractive index of the respective layer is determined in particular by the selected material of the layer, wherein at least two dielectric materials different in this respect should be found in the layer structure.

The transmission and reflection characteristics of the filters are determined by the design of the different layers of the filter, in particular the layer thickness thereof.

In principle, a desired spectral target function is the more readily achieved, the greater the difference between the refractive indices of the various layers of the filter. Where there is a large difference between the values of the refractive indices of the materials of the layers, the number of alternating layers and thus often the overall thickness of the interference filter may as a rule be reduced. If the lamp bulb consists in particular of quartz or the like, SiO₂ is often used as the material for the layer with the lower refractive index. When selecting the material of the layer with the higher refractive index, the conventional operating temperature range of UHP lamps must be taken into consideration, the upper range thereof being around 1000° C. Zirconium oxide (ZrO₂) for example exhibits temperature resistance which is satisfactory in this respect.

It is additionally preferable for the defined emission spectrum to be achievable by selecting a filter characteristic with regard to the ratio of the portions of the light which the interference filter allows to pass through or reflects.

The object of the invention is additionally achieved by a lighting unit as claimed in claim 8.

The lighting unit according to the invention, which emits light at least in a defined wavelength range with a defined emission spectrum, comprises at least one high-pressure discharge lamp as light source, which comprises a burner with a discharge chamber, and two electrodes extending into the discharge chamber, which are arranged opposite one another and on the longest axis of symmetry of the high-pressure discharge lamp, a multilayer interference filter, through which at least a portion of the light from the defined wavelength range may pass, and a reflector, which is arranged in the beam path between the light source and the interference filter and which reflects into the space between the two electrodes at least a portion of the light from the defined wavelength range which has not passed through the interference filter.

The invention will be further described with reference to examples of embodiment shown in the drawings to which, however, the invention is not restricted. In the Figures:

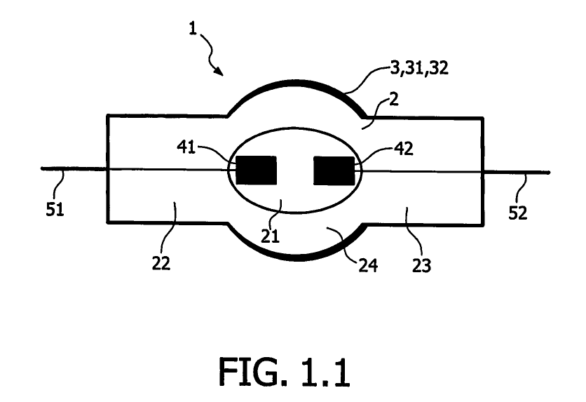

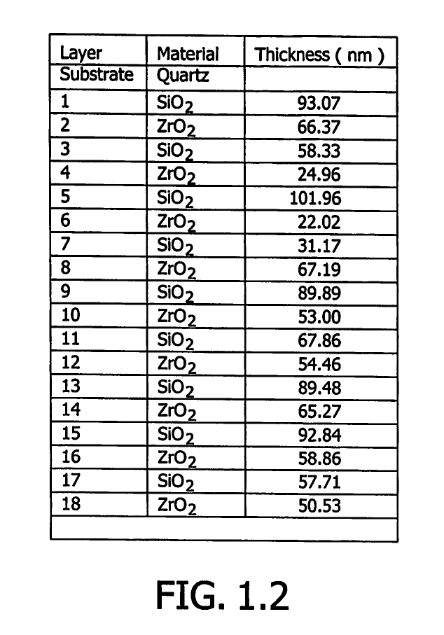

FIG. 1 is a schematic sectional representation of a lamp bulb of a high-pressure gas discharge lamp (UHP lamp) bearing an 18-layer interference filter, and

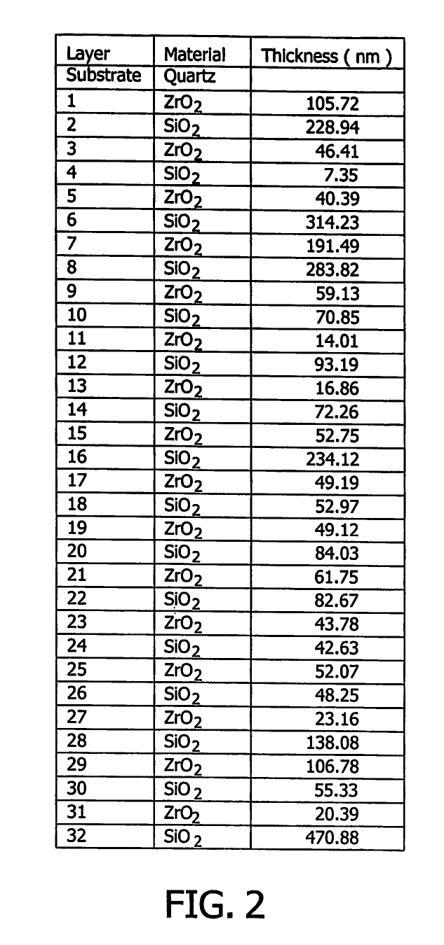

FIG. 2 shows the design of a 32-layer interference filter of a lighting unit according to the invention.

FIG. 1 is a schematic, sectional representation (FIG. 1.1) of a lamp bulb 1 with symmetrical discharge chamber 21 of a high-pressure gas discharge lamp (UHP lamp) according to the invention. The one-piece burner 2, which hermetically seals the discharge chamber 21 filled with a gas conventional in this respect and the material of which is conventionally hard glass or silica glass, comprises two cylindrical, mutually opposing zones 22, 23 between which there is located a substantially spherical zone 24 with a diameter of approximately 9 mm. The outer contour of the burner 2 in the area of the discharge chamber 21 is elliptical in shape. The elliptically shaped discharge chamber 21 with an electrode arrangement is arranged centrally in the zone 24. The electrode arrangement comprises substantially a first electrode 41 and a second electrode 42, between the opposing tips of which an arc discharge is induced in the discharge chamber 21, wherein the arc serves as light source for the high-pressure gas discharge lamp. The ends of the electrodes 41, 42, which are arranged on the longest axis of symmetry of the discharge chamber 21, are connected to electrical terminals 51, 52 of the lamp, via which the supply voltage necessary for operation of the lamp is supplied by a power supply, not illustrated in FIG. 1.1, designed for a general line voltage.

An interference filter 3 is arranged over the entire outer surface of the zone 24. The interference filter 3 is altogether approximately 1.2 μm thick, comprising a plurality of layers. The design of the interference filter 3 or its structure is clear from FIG. 1.2. The interference filter 3 is an 18-layer structure, wherein the total layer thickness of the layers of SiO₂ amounts to approximately 682 nm and the total layer thickness of the layers of ZrO₂ amounts to approximately 467 nm.

The two different layers 3.1 and 3.2 of the interference filter 3 are characterized in particular by a different refractive index, wherein a layer with a low index alternates with one with a higher index. SiO₂ serves as the material for layer 3.2 with the lower refractive index; ZrO₂ serves as the material for layer 3.1 with the higher index.

The interference filter 3 principally reflects light from the wavelength range of approx. 420 to approx. 530 nm and principally lets pass light from the wavelength range (defined wavelength range) of greater than approx. 520 nm. A portion of the light from the wavelength range (defined wavelength range) of greater than approx. 520 nm is reflected according to the invention into the area between the two electrodes 41 and 42, in order there to be at least partially reabsorbed.

The layered application of the interference filter 3 is performed during the manufacturing process by a sputtering method known per se.

In the case of a UHP lamp with the above-described lamp bulb 1 and operated at a nominal power of 120 W, no substantial impairment beyond the normal ageing of comparable lamps could be noted, even after several thousand operating hours in the full/high load range,

The UHP lamp according to the invention was measured at a power input of 120 W with regard to its luminous and electrical characteristics by means of standard measuring methods using a so-called Ulbricht sphere. The radiant power amounted to 22.91 W in the visible light range (approx. 400-780 nm). In the case of a quantity of light of 5853 lm, an efficiency of 48.8 lm/W was thus obtained. The color temperature amounted to 4256 K in the case of a red ratio of approx. 12.8%. With regard to the desired (defined) emission spectrum, a low color temperature is the aim.

A similar measurement of a comparable UHP lamp—but without the above-mentioned interference filter 3—produced the following values, on the other hand. The radiant power amounted to 30.97 W in the visible light range (approx. 400-780 nm). In the case of a quantity of light of 7325 lm, an efficiency of 61.3 lm/W was thus obtained. The color temperature amounted to 7791 K in the case of a red ratio of approx. 8.7%.

A particularly advantageous development of the invention relates to a high-pressure gas discharge lamp which serves for projection purposes.

Further details, features and advantages of the invention are revealed by the following description of a further preferred embodiment.

With regard to the desired (defined) emission spectrum, an improved color rendering index is the aim here.

The lighting unit consists at least of a standard UHP lamp, i.e. in particular the UHP lamp does not itself have any interference filter. The UHP lamp is adjusted and fixed in a reflector in the conventional manner.

The lighting unit additionally comprises a multilayer interference filter, through which at least a portion of the light from the defined wavelength range may pass and which is applied to a planar carrier substrate, for example of silica glass, by means of a sputtering method known per se. The planar carrier substrate is positioned in the output light beam of the reflector.

The reflector, which is arranged in the beam path between the light source and the interference filter, allows at least a portion of the light from the defined wavelength range, which portion has not passed through the interference filter, to be reflected into the space between the two electrodes.

The lighting unit according to the invention with an interference filter according to FIG. 2 was measured at a UHP lamp power input of 120 W with regard to its color rendering index by means of standard measuring methods. The color temperature amounted to 6016 K in the case of a red ratio of approx. 12.1% and a color rendering index Ra8 of 74.6.

A similar measurement of a comparable lighting unit with a UHP lamp—but without the above-mentioned interference filter 3—produced the following values, on the other hand. The color temperature amounted to 7939 K in the case of a red ratio of approx. 9.1% and a color rendering index Ra8 of 65.0.

1. A high-pressure discharge lamp, which emits light at least in a defined wavelength range with a defined emission spectrum, having at least
a burner (2) which comprises a discharge chamber (21), wherein at least the outer contour of the burner (2) has an elliptical shape in the area of the discharge chamber (21),
two electrodes (41, 42) extending into the discharge chamber (21), which electrodes are arranged opposite one another and on the longest axis of symmetry of the discharge chamber (21), and
a multilayer interference filter (3), which is arranged at least on the outer contour of the burner (2) in the area of the discharge chamber (21), wherein at least a portion of the light from the defined wavelength range can pass through the interference filter (3) and another portion of the light from the defined wavelength range can be reflected into the space between the two electrodes (41, 42).

2. A high-pressure discharge lamp as claimed in claim 1, characterized in that a layer (3.1) with a higher refractive index alternates with a layer (3.2) with a lower refractive index in the layer structure of the multilayer interference filter (3).

3. A high-pressure discharge lamp as claimed in claim 1, characterized in that the layer (3.2) of the interference filter (3) with the lower refractive index preferably consists predominantly of SiO₂ and the second layer (3.1) of the interference filter (3) consists of a material, preferably predominantly of zirconium oxide (ZrO₂), which has a higher refractive index than SiO₂.

4. A high-pressure discharge lamp as claimed in claim 3, characterized in that the second layer (3.1) consists of a material from the group comprising titanium oxide, tantalum oxide, niobium oxide, hafnium oxide, silicon nitride, particularly preferably zirconium oxide ZrO₂, or a mixture of these materials.

5. A high-pressure discharge lamp as claimed in claim 1, characterized in that the defined emission spectrum is achievable by selecting a filter characteristic with regard to the ratio of the portions of the light which the interference filter allows to pass through and reflects.

6. A high-pressure discharge lamp as claimed in claim 1, characterized in that the high-pressure gas discharge lamp is a UHP lamp.

7. A projection system, endoscope system with optical fiber cable or lighting system with at least one lamp as claimed in claim 1.

8. A lighting unit, which emits light at least in a defined wavelength range with a defined emission spectrum, having at least
one high-pressure discharge lamp as s light source, which comprises a burner with a symmetrical discharge chamber and two electrodes extending into the discharge chamber, which electrodes are arranged opposite one another and on the longest axis of symmetry of the high-pressure discharge lamp,
a multilayer interference filter, through which at least a portion of the light from the defined wavelength range can pass, and
a reflector which is arranged in the beam path between the light source and the interference filter and which reflects at least a portion of the light from the defined wavelength range, which portion has not passed through the interference filter, into the space between the two electrodes.

9. An endoscope system with optical fiber cable, lighting system or projection system having at least one lighting unit as claimed in claim 8.
